(19) United States
(12) Patent Application Publication
(10) Pub. No.: US 2007/0154674 A1
(43) Pub. Date: Jul. 5, 2007

(54) Recordable optical media with thermal buffer layer

(75) Inventors: Stanley C. Busman, North St. Paul, MN (US); Daniel P. Stubbs, Marine on St. Croix, MN (US); Richard F. Willson, Hudson, WI (US)

Correspondence Address: Imation Legal Affairs, P.O. Box 64898, St. Paul, MN, 55164-0898, US

(73) Assignee: Imation Corp.

(21) Appl. No.: 11/321,731

(22) Filed: Dec. 29, 2005

(51) Int. Cl. B32B 3/02

(52) U.S. Cl. 428/64.4; 428/64.6

(57) ABSTRACT

The invention is directed to a recordable optical data storage medium that includes a thermal buffer layer formed between a substrate and a recording dye layer of the recordable optical data storage medium. In addition, multi-recording-layer optical media are described, which incorporate such thermal buffer layers between a recording dye and a substrate, and also between another recording dye layer and a spacer layer. In accordance with the invention, the thermal buffer layer or layers comprise a silicon-oxi-nitride (SiO_{X}N_{(2/3)(2-X)}), wherein X is between approximately 0.1 and 1.9.

### TECHNICAL FIELD

The invention relates to optical data storage media and, more particularly, to writeable optical disks.

### BACKGROUND

Optical data storage disks have gained widespread acceptance for the storage, distribution and retrieval of large volumes of information. Optical data storage disks include, for example, audio CD (compact disc), CD-R (CD-recordable), CD-RW (CD-rewritable) CD-ROM (CD-read only memory), DVD (digital versatile disk or digital video disk), DVD-RAM (DVD-random access memory), and various other types of writable or rewriteable media, such as magneto-optical (MO) disks, phase change optical disks, and others. Some newer formats for optical data storage disks are progressing toward smaller disk sizes and increased data storage density. For example, some new media formats boast improved track pitches and increased storage density using blue-wavelength lasers for data readout and/or data recording.

Some optical data storage disks, such as read-only disks, include a substrate and a reflector. A surface pattern can be replicated on the substrate. The surface pattern may be a collection of features that define pits and lands, e.g., typically arranged in either a spiral or concentric manner. An optical drive can focus a laser to reflect light off the reflector of the read-only disk so that the features replicated on the substrate can be detected for information readout.

In the case of recordable optical media, the optical data storage disk may further include a dye, which is typically positioned between the substrate and the reflector. The dye comprises the recordable layer of the recordable optical media. High intensity laser light can be focused on the dye to cause the dye to change in a manner that can be detected in subsequent readout. In particular, the laser light used for the recording may raise the temperature of the dye above its thermal decomposition temperature. When this occurs, the optically reflective properties of the medium change, which allows information to be recorded on the medium. A lower intensity readout laser can then be used to read the information that is recorded on the medium.

Blue disk media formats, such as Blu-Ray and HD-DVD, may comprise a similar structure to other optical disk formats. Unlike conventional CD and DVD formats, the blue disk media formats may be compatible with a blue-laser drive head that operates at a wavelength of approximately 405 nm, which can allow for smaller track pitches. The blue disk media formats include optically transmissive cover layers, e.g., a thin cover sheet in the case of Blu-Ray and an incident substrate in the case of HD-DVD, bonded over the optical disk with different thicknesses specified by the different blue disk media formats. These and other optical disk formats will continue to emerge and evolve.

### SUMMARY

In general, the invention is directed to a recordable optical data storage medium that includes a thermal buffer layer formed between a substrate and a recording dye layer of the recordable optical data storage medium. The thermal buffer layer may thermally insulate the substrate, or dissipate heat to the substrate over a large area of the substrate when the recording dye is interrogated by a laser during information recording. In this manner, the thermal buffer layer protects the substrate from deformation by the heat of the laser that interrogates the dye to raise the temperature of the dye above its thermal decomposition temperature. In accordance with the invention, the thermal buffer layer comprises a silicon-oxi-nitride (SiO_{X}N_{(2/3)(2-X)}), wherein X is between approximately 0.1 and 1.9.

In one embodiment, the invention provides an optical data storage medium comprising a first substrate, a thermal buffer layer formed over the first substrate, a dye layer formed over the thermal buffer layer, a reflector layer formed over the dye layer, and a second substrate bonded to the reflector layer. The thermal buffer layer comprises SiO_{X}N_{(2/3)(2-X)}, wherein X is between approximately 0.1 and 1.9.

In another embodiment, the invention provides an optical data storage medium that includes two or more recordable layers. In this case, the optical data storage medium may comprise a first substrate, and a first thermal buffer layer formed over the first substrate, wherein the first thermal buffer layer comprises SiO_{X}N_{(2/3)(2-X)}, wherein X is between approximately 0.1 and 1.9. The optical data storage medium may further include a first dye layer formed over the first thermal buffer layer, and a first reflector layer formed over the first dye layer, wherein the first reflector layer is a semi-transparent reflector layer. In addition, the optical data storage medium may also include a spacer layer formed over the first reflector layer, and a second thermal buffer layer formed over the spacer layer, wherein the second thermal buffer layer comprises SiO_{X}N_{(2/3)(2-X)}, wherein X is between approximately 0.1 and 1.9. Finally, the optical data storage medium may also include a second dye layer formed over the second thermal buffer layer, a second reflector layer formed over the second dye layer, and a second substrate over the second reflector layer.

The invention may be capable of providing one or more advantages. For example, by incorporating a thermal buffer layer in a recordable optical medium that uses a recording dye, the invention can reduce or eliminate undesirable melting or softening of the substrate that may otherwise occur during information recording when the recording dye is interrogated by a laser to raise its temperature above a decomposition temperature. Similarly, for optical media having multiple recording dye layers, thermal buffer layers can also reduce or eliminate undesirable melting or softening of polymer bonding layers. The optical properties of the thermal buffer layer may also be tuned to ensure good optical performance of the medium. A layer of SiO_{X}N_{(2/3)(2-X)}, wherein X is between approximately 0.1 and 1.9, may achieve particularly good results for one or more thermal buffer layers.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is conceptual side view of an optical data storage medium according to an embodiment of the invention.

FIG. 2 is a conceptual close-up side view of a portion of an optical data storage medium according to an embodiment of the invention.

FIG. 3 is conceptual side view of an optical data storage medium that includes two dye layers and two thermal buffer layers according to an embodiment of the invention.

FIG. 4 is a graph illustrating modeled results.

### DETAILED DESCRIPTION

The invention is directed to a recordable optical data storage medium that includes a thermal buffer layer comprising a silicon-oxi-nitride (SiO_{X}N_{(2/3)(2-X)}), wherein X is between approximately 0.1 and 1.9. The thermal buffer layer may be formed between a substrate and a recording dye layer of the recordable optical data storage medium. Also, for media having multiple recording dye layers, a thermal buffer layer may also be formed adjacent polymer bonding layers of such media. A thermal buffer layer may thermally insulate the substrate, or dissipate heat to a larger area of the substrate when the recording dye is interrogated by a laser during information recording. Similarly, for media having multiple recording dye layers, a thermal buffer layer may also protect one or more polymer bonding layers when the recording dye is interrogated by a laser during information recording.

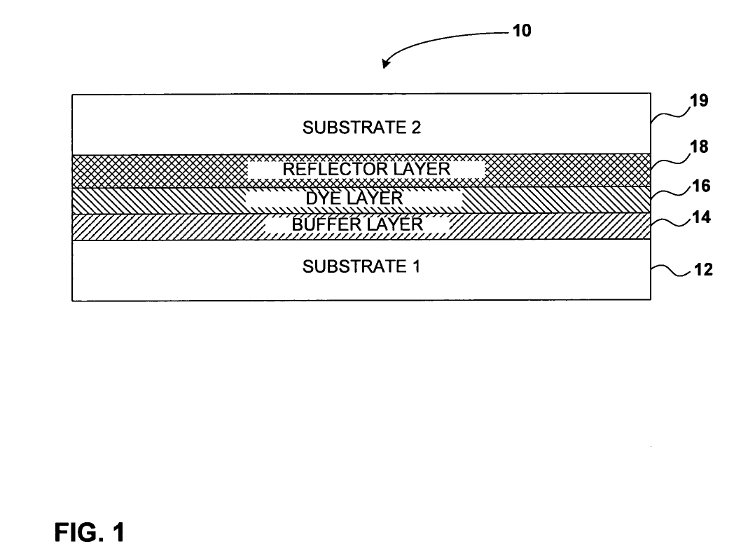

FIG. 1 is conceptual side view of an optical data storage medium 10 according to an embodiment of the invention. Optical data storage medium 10 includes a first substrate 12, a buffer layer 14 formed over first substrate 12, and a dye layer 16 formed over buffer layer 14. In addition, optical data storage medium 10 includes a reflector layer 18 formed over dye layer 16 and a second substrate 19 bonded to reflector layer 18. In this disclosure, the terms “buffer layer” and “thermal buffer layer” are used interchangeably, as the invention concerns a buffer layer to provide thermal protection between a dye layer and another layer of an optical medium.

Optical data storage medium 10 may comply with any optical medium format that allows for the use of a recording dye, which is recorded by raising the dye temperature above a decomposition temperature of the dye. Additional layers may also be formed between the layers illustrated in FIG. 1. However, optical data storage medium 10 may preferably consist of layers 12, 14, 16, 18, 19 and the bonding material between layers 18 and 19. In other words, the different layers of optical data storage medium 10 may be formed adjacent one another, as illustrated, but the invention is not necessarily limited in this respect. Importantly, buffer layer 14 acts as a thermal buffer between dye layer 16 and substrate 12 in order to insulate or dissipate heat in a manner that protects substrate 12 from softening when dye layer 16 is interrogated by a recording laser of an optical disk drive during information recording.

Optical data storage medium 10 may comprise a recordable DVD, such as a DVD-R or DVD-RW, or another type of optical disk. However, the invention is not limited to any specific format, and may find wide application with another of formats, including one of the emerging blue-disk formats.

Substrate 12 may comprise a thermoplastic material, such as polycarbonate, although other clear polymers or other materials may also be used. Substrate 12 may be injection molded to a thickness of approximately 0.6 millimeters. However, other fabrication techniques and other substrate thicknesses may also be used. Substrate 12 may be formed to include a surface relief pattern of pits and lands, or another type of replica features commonly formed on optical media substrates. The surface relief pattern may be arranged in a concentric or spiral manner on the surface of substrate 12, and may be formed using mastering and stamping techniques common in optical disk fabrication. The surface relief pattern defines information storage domains for medium 10.

Dye layer 16 comprises a recording dye that can be interrogated by a laser to raise its temperature above a decomposition temperature. In this manner, dye layer 16 facilitates the recording of information on medium 10. When the temperature of a domain of dye layer 16 is raised above the decomposition temperature, the corresponding portion of dye layer 16 decomposes and thereby changes the optical properties of medium 10 at or near that domain. In this manner, information can be recorded on medium. Dye layer 16 may comprise any recording dye commonly used in optical disks. Examples of recording dyes that may be used for dye layer 16 include azo/metal azo dyes, phthalocyanine/metal phthalocyanine dyes, porphyrin/metal porphyrin dyes, formazan metal complex dyes, metal (e.g. Ni, Cr) complex dyes, cyanine dyes, merocyanine dyes, hemicyanine dyes, streptocyanine dyes, oxonol dyes, coumarin dyes, squarylium dyes, styryl dyes, anthraquinone dyes, polyacene dyes, pyrylium/thiopyrylium dyes, and triphenylmethane dyes, although other dye layer materials could be used. Dye layer 16 may have a thickness between approximately 30 and 150 nm.

Unfortunately, the softening temperature of substrate 12 may be less than the decomposition temperature of dye layer 16. In this case, deformation of substrate 12 is of particular concern when a domain of dye layer 16 is raised above the decomposition temperature. If the heating of dye layer 16 causes deformation of substrate 12, media quality can be compromised.

For this reason, optical data storage medium 10 includes a thermal buffer layer 14 formed between dye layer 16 and substrate 12. Thermal buffer layer 14 acts as a thermal barrier to either insulate or dissipate heat from dye layer 16 in a manner that protects substrate 12 from deformation. For example, thermal buffer layer 14 may be a heat insulator, but is preferably a thermally conductive material that is at least five times more thermally conductive than substrate 12. In this case, when a small domain of dye layer 16 is heated, the heat is transferred to buffer layer 14 and spread over a much larger surface area of substrate 12 at significantly lower temperature. In this manner, substrate 12 can be protected from the heat generated in dye layer 16, and substrate deformation can be reduced or avoided.

In accordance with the invention, buffer layer 14 comprises a silicon-oxi-nitride (SiO_{X}N_{(2/3)(2-X)}), wherein X is between approximately 0.1 and 1.9. Experiments have shown such a silicon-oxi-nitride to function well as a thermal buffer between a substrate and a dye. Buffer layer 14 may be formed on medium 10 during media fabrication by sputtering from a silicon target in a controlled atmosphere of argon, oxygen and nitrogen. The relative amounts of gases can be selected in order to achieve a desired level of oxygen and nitrogen in buffer layer 14. The relative amounts of gases may also be used to tune the optical properties of the buffer layer 14 so as to ensure good optical performance of medium 10. By way of example, buffer layer 14 may have a thickness between approximately 30 nanometers and 200 nanometers. In particular, buffer layer 14 may need to be greater than 30 nanometers in order to ensure that adequate heat dissipation is achieved. Moreover, buffer layer 14 may need to be less than 200 nanometers in order to ensure that stress problems do not manifest between buffer layer 14 and layers or materials adjacent to buffer layer 14.

Reflector layer 18 is formed over dye layer 16 so that incident laser light through substrate 12 can be reflected from medium 10 for information readout. Reflector layer 18 may comprise a substantially reflective thin film material, such as silver, aluminum, or alloys thereof. However, numerous other types of reflective materials could also be used, and in some cases, reflector layer 18 may comprise two or more materials combined to form a substantially reflective thin film stack. A second substrate 19 is adhered adjacent reflector 14 with an adhesive. The adhesive may be a photosensitive adhesive that is cured, a temperature or pressure sensitive adhesive, or any other type of adhesive used in optical media fabrication.

When data storage medium 10 is inserted into a disk drive, first substrate 12 comprises an incident substrate to the read/write optics of the disk drive. First substrate 12 and second substrate 19 may have similar thicknesses, although the invention is not necessarily limited in this respect. By way of example, both of substrates 12 and 19 may be approximately 0.6 millimeters thick. Unlike first substrate 12, however, second substrate 19 may be a blank substrate that does not include a pattern of replicated surface features.

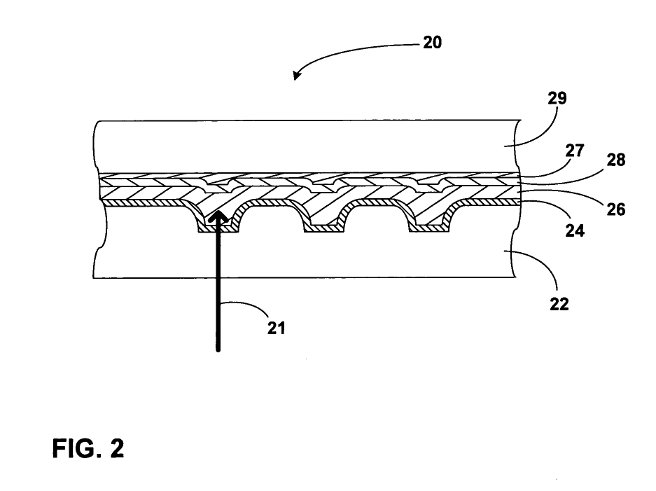

FIG. 2 is a conceptual close-up side view of a portion of an optical data storage medium 20 according to an embodiment of the invention. Medium 20 may substantially correspond to medium 10 of FIG. 1. Medium 20 includes a first substrate 22 that is formed to include a pattern of replicated surface features, a buffer layer 24 formed over first substrate 22, and a dye layer 26 formed over buffer layer 24. In addition, optical data storage medium 10 includes a reflector layer 28 formed over dye layer 26 and a second substrate 29 bonded to reflector layer 28 via bonding layer 27.

In many write once optical disc systems such as CD-R and DVD+/−R where a dye is used as the recordable material, a focused laser spot is commonly used to raise the temperature of the dye layer above its thermal decomposition temperature. In this recording process, it is commonly observed that an underlying polycarbonate substrate layer becomes deformed as a result of interrogating the dye. For example, the polycarbonate commonly used in substrates may deform when it is raised above its softening temperature when the recording laser interrogates the dye layer.

FIG. 2 shows an input laser 21 interrogating medium 20 in order to raise the temperature of dye layer 26 at a location of a pit formed in substrate 22. When this is done, heating of substrate 22 may occur in the substrate area corresponding to the pit, causing deformation that can undermine the desired optical properties of the pit. For this reason, medium 20 includes buffer layer 24, which dissipates heat generated in a small location on dye layer 26 over a larger area of substrate 22, thereby reducing localized heating of substrate 22 in a manner that could otherwise cause substantial substrate deformation. Accordingly, buffer layer 22 protects substrate 22 from undesirable localized melting (or softening), that otherwise result from input laser 21 interrogating medium 20 to raise the temperature of dye layer 26. As described herein, buffer layer 24 comprises silicon-oxi-nitride (SiO_{X}N_{(2/3)(2-X)}), wherein X is between approximately 0.1 and 1.9.

Microscopic analysis of conventional CD and DVD recordable discs (without a buffer layer) have shown that deformation can result in a bump in polycarbonate that protrudes into a groove, pit or other surface-replicated optical feature. In the case of higher speed media (e.g. 16× DVD+R) or higher density blue formats, the localized melted substrate areas may predominately appear at the trailing and leading edge of a written mark. This localized substrate deformation can cause the leading or trailing edge of the readout signal of the mark to be distorted, making it more difficult to find a write strategy for successful low jitter readout of the optically encoded data.

Deformation of a polycarbonate substrate can also cause inter-symbol interference (ISI) which is undesirable and especially harmful at the higher recording densities of the HD-DVD and BluRay formats. Accordingly, the invention may be particularly useful for these or other new high density formats, where substrate deformation can be more problematic.

The buffer layer described herein may be applied in a vacuum deposition process similar to that outlined in the experimental example provided below. Alternatively, the buffer layer may be applied in spin-coating step prior to forming the dye layer. The dye layer is typically spin-coated, and the reflector layer is typically deposited using vacuum deposition. Other techniques for forming the different layers, however, may also be used.

In some embodiments, multiple silicon-oxi-nitride buffer layers may be included for media that includes multiple dye layers in order to provide multiple layers of information storage. In these cases, one silicon-oxi-nitride buffer layer may be formed over a substrate, while one or more other silicon-oxi-nitride buffer layers may be formed over one or more polymer spacer layers of the medium. For example, the same deformation concerns with respect to the substrate may also apply to spacer layers commonly used in multi-layer optical media.

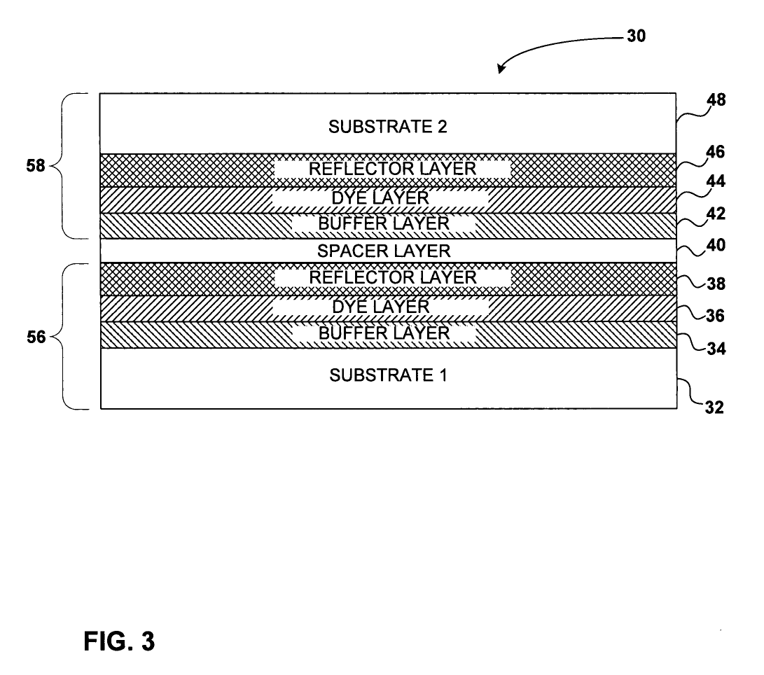

FIG. 3 is conceptual side view of an optical data storage medium 30 that includes two dye layers and two thermal buffer layers according to an embodiment of the invention. As shown in FIG. 3, optical data storage medium 30 includes a first substrate 32, a first buffer layer 34 formed over first substrate 32, and a first dye layer 36 formed over buffer layer 34. In addition, optical data storage medium 30 includes a first reflector layer 38 formed over first dye layer 36.

First reflector layer 38 comprises a partially reflective layer, e.g., a semi-transparent reflector layer that may reflect only a portion of incident light. As an example, first reflector layer 38 may reflect only approximately 50 percent of incident light, and may transmit the remaining 50 percent of light. In any case, light that reflects from reflector layer 38 may be used for recording and/or information readout of features formed on substrate 32 and thermal decomposition performed with respect to first dye layer 36.

Optical data storage medium 30 also includes a spacer layer 40, which may comprise a polymer material replicated with optical features (such as pits and grooves). In the final construction, spacer layer 40 is formed over reflector layer 38 relative to the direction of input light used for information recording and readout, which interrogates through substrate 32. In other words, incoming light encounters spacer layer 40 after reflector layer 38. However, spacer layer 40 may be replicated and applied last in media fabrication, and can be used to attach portion 56 to portion 58 of optical data storage medium 30 to form the final construction.

Optical data storage medium 30 also includes a second buffer layer 42 formed over spacer layer 40, a second dye layer 44 formed over second buffer layer 42, a second reflector layer 46 formed over second dye layer 44 and a second substrate 48 over second reflector layer 46. The second reflector layer 46 may more reflective than the first reflector layer 38. Optical data storage medium 30 may preferably consist of layers 32, 34, 36, 38, 40, 42, 44 and 46, but in other embodiments, other layers may also exist. In other words, the different layers of optical data storage medium 30 may be formed adjacent one another, as illustrated, but the invention is not necessarily limited in this respect insofar additional layers may be included between various layers that are formed over one another.

Substrates 32 and 48 may each comprise a thermoplastic material, such as polycarbonate, although other clear polymers or other materials may also be used. Substrates 32 and 48 may be injection molded to a thickness of approximately 0.6 millimeters, although other fabrication techniques and other substrate thicknesses may also be used. Both of substrates 32 and 48 may be formed to include surface relief patterns of pits and lands, or any other type of replica features commonly formed on optical media substrates. Alternatively, substrate 32 may include a surface relief pattern and substrate 48 may be a blank substrate that does not include a surface relief pattern. In this case, the relief pattern that defines the pits and grooves for information storage in second dye layer 44 may be replicated into spacer layer 40.

In any case, the relief patterns may be arranged in a concentric or spiral manner on the surface of substrate 32, the surface of substrate 48, and/or within spacer layer 40. The surface relief patterns define information storage domains for medium 30.

Dye layers 36 and 44 may comprise recording dyes that can be interrogated by a laser to raise the respective dye temperatures above a decomposition temperature. In this manner, dye layers 36 and 44 facilitate the recording of information on two different layers of medium 30. When the temperature of a domain of dye layer 36 is raised above the decomposition temperature, the corresponding portion of dye layer 36 decomposes and thereby changes the optical properties of medium 30 at that domain. Similarly, when the temperature of a domain of dye layer 44 is raised above the decomposition temperature, the corresponding portion of dye layer 44 decomposes and thereby changes the optical properties of medium 40 at that domain.

In this manner, information can be recorded on medium in two different dye layers. Dye layers 36 and 44 may each comprise any recording dye commonly used in optical disks. Examples of recording dyes that may be used for dye layers 36 and 44 include azo/metal azo dyes, phthalocyanine/metal phthalocyanine dyes, porphyrin/metal porphyrin dyes, formazan metal complex dyes, metal (e.g. Ni, Cr) complex dyes, cyanine dyes, merocyanine dyes, hemicyanine dyes, streptocyanine dyes, oxonol dyes, coumarin dyes, squarylium dyes, styryl dyes, anthraquinone dyes, polyacene dyes, pyrylium/thiopyrylium dyes, and triphenylmethane dyes, although other dye layer materials could be used. Dye layers 36 and 44 may have thicknesses between approximately 30 and 150 nm.

Like in medium 10 of FIG. 1, in medium 30 of FIG. 3, heating of the recording dyes can be problematic. In particular, the softening temperature of substrate 32 may be less than the decomposition temperature of dye layer 36. Similarly, the softening temperature of spacer layer 40 may be less than the decomposition temperature of dye layer 44. In these cases, deformation of substrate 32 is of particular concern when a domain of dye layer 36 is raised above the decomposition temperature, and deformation of spacer layer 40 is of similar concern when a domain of dye layer 44 is raised above the decomposition temperature. If the heating of either of dye layers 36 or 44 causes deformation of either of substrate 32 or spacer layer 44, media quality can be compromised.

For this reason, optical data storage medium 10 includes a first thermal buffer layer 34 formed between dye layer 36 and substrate 32, and a second thermal buffer layer 42 formed between dye layer 44 and spacer layer 40. Thermal buffer layer 34 acts as a thermal barrier to either insulate or dissipate heat from dye layer 36 in a manner that protects substrate 32 from deformation. Similarly, thermal buffer layer 42 acts as a thermal barrier to either insulate or dissipate heat from dye layer 44 in a manner that protects spacer layer 40 from deformation.

Each of thermal buffer layers 34 and 42 may be heat insulators, but are preferably thermally conductive materials that are at least approximately five times more thermally conductive than substrate 32 and spacer layer 40. In this case, when a small domain of dye layer 36 is heated, the heat is transferred to buffer layer 34 and spread over a much larger surface area of substrate 32 at significantly lower temperature. Also, when a small domain of dye layer 44 is heated, the heat is transferred to buffer layer 42 and spread over a much larger surface area of spacer layer 40 at significantly lower temperature. In this manner, substrate 32 and spacer layer 40 can be protected from the heat generated in dye layers 36 and 44 respectively, and media deformation can be reduced or avoided.

Medium 30 is generally a dual layer optical storage medium insofar as two information storage layers are present at different depths of the medium. Therefore, first reflector layer 38 is only partially reflective so that some light can be transmitted through layer 38 for reflection off of second reflector layer 46 for information writing and readout of with respect to second dye layer 44 and features replicated or formed in either spacer layer 40 or second substrate 48. Reflector layers 38 and 46 may comprise silver, silver alloys, aluminum, aluminum alloys, or any suitable reflective materials. The composition and thicknesses may be tuned to provide a desired level to refection and transmission for the respective layers.

In accordance with the invention, buffer layers 34 and 42 may comprise a silicon-oxi-nitride (SiO_{X}N_{(2/3)(2-X)}), wherein X is between approximately 0.1 and 1.9. Buffer layers 34 and 42 may be formed on during media fabrication by sputtering from a silicon target in a controlled atmosphere of argon, oxygen and nitrogen. The relative amounts of gases can be selected in order to achieve a desired level of oxygen and nitrogen in buffer layers 34 and 42. The relative amounts of gases may also be used to tune the optical properties of the buffer layers 34 and 42 so as to ensure good optical performance of medium 30. By way of example, each of buffer layers 34 and 42 may have a thickness between approximately 30 nanometers and 200 nanometers. Buffer layers 34 and 42 may need to be greater than approximately 30 nanometers in order to ensure that adequate heat dissipation is achieved. However, buffer layers 34 and 42 may need to be less than approximately 200 nanometers in order to ensure that stress problems do not manifest between buffer layers 34 and 42 and layers or materials adjacent to buffer layers 34 and 42.

In order to create medium 30, structures 56 and 58 may be formed separately, and then bonded together by spacer layer 40. For example, reflector layer 46 may be deposited on second substrate 48, and dye layer 44 may be spin coated on reflector layer 46. Buffer layer 42 may then be deposited on dye layer 44.

In a separate process, buffer layer 34 may be deposited on first substrate 32 and first dye layer 36 may be spin coated on buffer layer 34. Reflector layer 38 can then be deposited on dye layer 36. Finally, spacer layer 40, e.g., comprising a polymer material, may be used to bond structure 56 to structure 58 to form the final construction of medium 30.

Again, in order to define a relief pattern with respect to first dye layer 36, substrate 32 may be injection molded to include a surface relief pattern. Similarly, in order to define a relief pattern with respect to second dye layer 36, substrate 48 may be injection molded to include a surface relief pattern. Alternatively, substrate 48 may be a blank substrate that does not include a surface relief pattern, in which case, a pattern of features may be formed in spacer layer 38, e.g., using a photopolymer replication process (sometimes referred to as a “2P replication” process).

Additional layers may also be included in medium 30. For example, additional layers may be applied between the various layers. Also, additional layers may be defined to provide three, four, or more than four information recording layers. When more information recording layers are used, each subsequent reflector layer may be progressively more reflective in order to define approximately equal light intensity for the different dye layers when an input laser is used for readout. Each dye layer used may have a corresponding thermal buffer layer to protect adjacent layers from deformation when the dye layer is heated.

### EXAMPLE 1

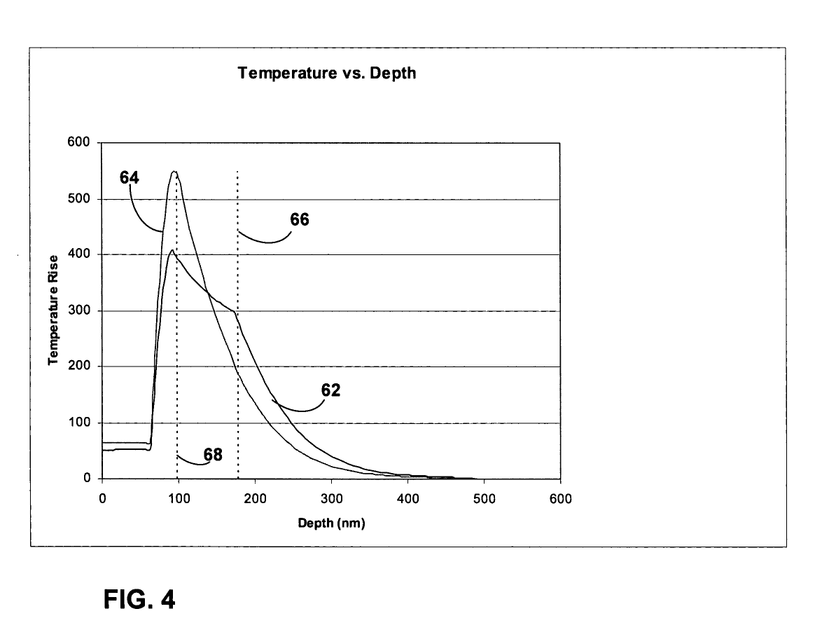

FIG. 4 is a graph showing experimental results of a simulated temperature profile for two different samples. A first sample included a 40 nm layer of a commercially available dye with real index of 1.85 and imaginary index of 0.19 with an 80 nm silicon-oxi-nitride buffer layer, followed by a 64 nanometer reflector layer. A second (comparative) sample included a 40 nm layer of the same dye followed by a 64 nanometer reflector layer, i.e., without the silicon-oxi-nitride buffer layer. A graph of the first sample (that included the silicon-oxi-nitride buffer layer) is labeled 62. A graph of the second sample (that did not include the silicon-oxi-nitride buffer layer) is labeled 64. Line 66 corresponds to the substrate interface for the first sample and line 68 corresponds to the substrate interface for the second sample.

An experimental simulation was carried out using Temprofile® from MMResearch, Inc., of Tucson Ariz. For both samples, 64 nm of reflector was defined from depth=0 to 64 nm. Polycarbonate substrates were use for both samples, which melt around 160° C. As can be seen from FIG. 4, for the second sample (that did not include the buffer layer), almost 90 nm of the substrate was above 160° C. with a maximum temperature of 540° C. On the other hand, for the second sample (that included the silicon-oxi-nitride buffer layer) only 40 nm of the substrate was above 160° C. with a maximum temperature of only about 300° C. The results of Example 1 validate the fact that a silicon-oxi-nitride buffer layer can help protect a substrate from extreme temperatures that manifest with dye interrogation by a laser.

### EXAMPLE 2

Another experiment was carried out with same dye used in Example 1. Substrates were prepared with no buffer layer and with 2 types of buffer layers. Buffer layers of 80 nm of ZnS:SiO₂ and 84 nm of silicon-oxi-nitride were deposited on bare substrates. The ZnS:SiO₂ was RF sputtered at 2 MTorr argon gas pressure from a target where the ZnS to SiO2 atomic ratio was 80:20. The silicon-oxi-nitride was Pulsed DC reactively deposited at 5 mTorr with gas flows of 29 standard cubic centimeters per minute (sccm) Ar+20 sccm N+31 sccm 10 mole % O₂/Ar. This resulted in a film having an index of refraction of 1.677 at wavelengths of 405 nm. At 405 nm wavelength, the refractive index was easily adjusted from ˜1.6 to 1.9. Therefore, it is observed that adjustment of refractive index of the silicon-oxi-nitride could be used to tune the reflectivity of the overall media construction.

The same dye used in Example 1 was coated on each of the 3 samples. 64 nm of Ag reflector was added, and the discs were bonded and tested. It was not possible to achieve measurable Partial Response Signal to Noise Ratio (PRSNR) or Simulated bit Error Rate SbER using the bare substrate or the ZnS:SiO₂ coated substrates. The ZnS:SiO₂ appeared to interact with the dye layer. However, in the case of the sample that included the silicon-oxi-nitride buffer layer, a PRSNR of greater than 14 dB and an SbER of 3×10⁻⁴ were obtained, showing significant promise for silicon-oxi-nitride.

Various embodiments of the invention have been described. For example, a silicon-oxi-nitride thermal buffer layer has been described for use between a substrate and a recording dye layer of the recordable optical data storage medium. In addition, multi-recording-layer optical media have been described, which incorporate such thermal buffer layers between a recording dye and a substrate, and also between another recording dye layer and a spacer layer. The invention is not limited to any specific optical disk format, and may be useful with many different optical disk formats, including new and emerging formats. Also, in some cases, the buffer layers described herein may comprise a silicon-oxi-nitride (SiO_{X}N_{1-X}), wherein X is between approximately 0.2 and 0.7. These and other embodiments are within the scope of the following claims.

1. An optical data storage medium comprising:
a first substrate;
a thermal buffer layer formed over the first substrate, wherein the thermal buffer layer comprises SiO_{X}N_{(2/3)(2-X)}, wherein X is between approximately 0.1 and 1.9;
a dye layer formed over the thermal buffer layer;
a reflector layer formed over the dye layer; and
a second substrate bonded to the reflector layer.

2. The optical data storage medium of claim 1, wherein thermal buffer layer is less than approximately 200 nanometer thick.

3. The optical data storage medium of claim 1, wherein the thermal buffer layer is greater than approximately 30 nanometers thick.

4. The optical data storage medium of claim 1, wherein the thermal buffer layer is between approximately 30 nanometers and 200 nanometers thick.

5. The optical data storage medium of claim 1, wherein the thermal buffer layer is at least approximately five times more thermally conductive than the first substrate.

6. The optical data storage medium of claim 1, wherein the thermal buffer layer protects the first substrate from deformation as a result of heat dissipation from laser interrogation of the dye layer.

7. The optical data storage medium of claim 1, wherein the first and second substrates comprises disk-shaped polycarbonate substrates, wherein the first substrate includes a pattern of replicated surface features, and wherein the second substrate is a blank substrate that does not include a pattern of replicated surface features.

8. The optical data storage medium of claim 1, wherein the reflector layer comprises silver.

9. The optical data storage medium of claim 1, wherein the dye layer comprises an azo/metal azo dye.

10. The optical data storage medium of claim 1, wherein the data storage medium consists of:
the first substrate;
the thermal buffer layer;
the dye layer;
the reflector layer;
the second substrate; and
a bonding material to bond the second substrate to the reflector layer.

11. An optical data storage medium comprising:
a first substrate;
a first thermal buffer layer formed over the first substrate, wherein the first thermal buffer layer comprises SiO_{X}N_{(2/3)(2-X)}, wherein X is between approximately 0.1 and 1.9;
a first dye layer formed over the first thermal buffer layer;
a first reflector layer formed over the first dye layer, wherein the first reflector layer is a semi-transparent reflector layer;
a spacer layer formed over the first reflector layer;
a second thermal buffer layer formed over the spacer layer, wherein the second thermal buffer layer comprises SiO_{X}N_{(2/3)(2-X)}, wherein X is between approximately 0.1 and 1.9;
a second dye layer formed over the second thermal buffer layer;
a second reflector layer formed over the second dye layer; and
a second substrate over the second reflector layer.

12. The optical data storage medium of claim 11, wherein the first and second thermal buffer layers are each less than approximately 200 nanometer thick.

13. The optical data storage medium of claim 11, wherein the first and second thermal buffer layers are each greater than approximately 30 nanometers thick.

14. The optical data storage medium of claim 11, wherein the first and second thermal buffer layers are each between approximately 30 nanometers and 200 nanometers thick.

15. The optical data storage medium of claim 11, wherein the first thermal buffer layer is at least five times more thermally conductive than the first substrate and wherein the second thermal buffer layer is at least five times more thermally conductive than the spacer layer.

16. The optical data storage medium of claim 11, wherein the first thermal buffer layer protects the first substrate from deformation as a result of heat dissipation from laser interrogation of the first dye layer and wherein the second thermal buffer layer protects the spacer layer from deformation as a result of heat dissipation from laser interrogation of the second dye layer.

17. The optical data storage medium of claim 11, wherein the first and second substrates comprises disk-shaped polycarbonate substrates, and wherein the spacer layer comprises a bonding material.

18. The optical data storage medium of claim 17, wherein the first substrate includes a first pattern of replicated surface features, and wherein the second substrate includes second pattern of replicated surface features.

19. The optical data storage medium of claim 17, wherein the first substrate includes a first pattern replicated features, wherein the second substrate is a blank substrate that does not include a pattern of replicated features, and wherein the spacer layer is photo-replicated to include a second pattern of features.

20. The optical data storage medium of claim 11, wherein the data storage medium consists of:
the first substrate;
the first thermal buffer layer;
the first dye layer;
the first reflector layer;
the spacer layer;
the second thermal buffer layer;
the second dye layer;
the second reflector layer; and
the second substrate.
